(19) United States
(12) Patent Application Publication
(10) Pub. No.: US 2013/0060686 A1
(43) Pub. Date: Mar. 7, 2013

(54) VIRTUAL DEBIT CARD

(71) Applicant: Randy MERSKY, Silver Spring, MD (US)

(72) Inventor: Randy MERSKY, Silver Spring, MD (US)

(21) Appl. No.: 13/464,207

(22) Filed: May 4, 2012

Related U.S. Application Data
(60) Provisional application No. 61/530,584, filed on Sep. 2, 2011.

(51) Int. Cl. G06Q 40/00

(52) U.S. Cl. 705/41; 705/35

(57) ABSTRACT

A method, system, terminal, and media for processing a request for a virtual debit card are provided. The terminal is configured to receive the request for the virtual debit card from a user and to transmit the request to a merchant processor. The request is anonymous with respect to the user. The merchant processor is configured to receive the request, determine a card number of the virtual debit card, and transmit the card number to the terminal. The terminal is configured to receive the card number from the merchant processor and to provide a receipt to the user including the card number. The terminal receives the request for the virtual debit card without receiving any personal identity information from the user and provides the receipt to the user without the card number being associated with the user.

### CROSS-REFERENCE TO RELATED APPLICATION

The present application claims the benefit of provisional application U.S. Pat. Appl. No. 61/530,584, filed on Sep. 2, 2011, the disclosure of which, including the specification and Figures, is incorporated herein by reference in its entirety.

### BACKGROUND

1. Field of the Disclosure

The present disclose generally relates to the field of electronic banking. More particularly, the present disclosure relates to various methods, systems, terminals, and media for providing virtual debit cards.

2. Background Information

A conventional debit card, also known as a bank card and a check card, is usually a plastic card that enables a cardholder electronic access to funds stored in a corresponding bank account at a financial institution. A debit card generally allows the cardholder instant access to the funds, typically for withdrawal, payment, or transfer. Unlike a credit card, the funds are automatically deducted from the cardholder's account, thus, eliminating the need for repayment at a later date and avoiding finance charges. A debit card is typically associated with a personal identification number (PIN), which is often required when accessing the funds in-person.

A virtual debit card is essentially an electronic version of a debit card that allows a cardholder to make electronic payments, transfers, and authorizations. In contrast, however, a virtual debit card is not typically associated with a personal identification number. Instead, a virtual debit card is generally associated with a card verification value (CVV2) or card identification number (CID). Oftentimes, virtual debit cards are prepaid and authorized by a card number and the card verification value or card identification number.

Debit cards and virtual debit cards have become increasing popular because of the money management options they offer. As a result, improved methods of providing and using debit cards and virtual debit cards are desired.

### SUMMARY OF THE DISCLOSURE

The present disclosure, through one or more of its various aspects, embodiments, and/or specific features or sub-components, provides various systems, servers, methods, media, and programs for processing a request for a virtual debit card.

According to a non-limiting embodiment of the present disclosure, a method for processing a request for a virtual debit card is provided. The method receives the request for the virtual debit card from a terminal via a network. The request specifies a card amount of the virtual debit card and is anonymous with respect to a user of the terminal. The method further determines at least a card number of the virtual debit card after receiving the request for the virtual debit card from the terminal. The card number of the virtual debit card is stored in a memory in association with the card amount of the virtual debit card. Thereafter the method includes transmitting at least the card number of the virtual debit card to the terminal via the network, wherein the card number is configured to be included on a receipt provided by the terminal to the user.

According to one aspect of the present disclosure, the request for the virtual debit card is received from the terminal without the terminal receiving any personal identity information from the user of the terminal.

According to another aspect of the present disclosure, the card number of the virtual debit card that is configured to be included on the receipt is configured to be provided to the user by the terminal without the card number being associated with the user by the terminal.

According to yet another aspect of the present disclosure, the request consists essentially of a terminal identifier for identifying the terminal and the card amount of the virtual debit card.

According to still another aspect of the present disclosure, the method further includes determining a security code and an expiration date of the virtual debit card after receiving the request for the virtual debit card from the terminal. The security code and the expiration date are stored in the memory in association with the card number and the card amount of the virtual debit card. The security code and the expiration date of the virtual debit card are transmitted to the terminal via the network, and the security code and the expiration code are configured to be included on the receipt provided by the terminal.

According to an additional aspect of the present disclosure, the method further includes assigning a unique transaction number to the request for the virtual debit card in response to receiving the request for the virtual debit card from the terminal. The unique transaction number is stored in the memory in association with the card number of the virtual debit card. The unique transaction number is transmitted to the terminal via the network and configured to be included on the receipt provided by the terminal along with the card number of the virtual debit card.

According to another aspect of the present disclosure, the method further includes receiving a second request from the user via the network. The second request includes the unique transaction number and is anonymous with respect to the user and non-identifying of the card number of the virtual debit card. Thereafter, the card number of the virtual debit card is determined based on the unique transaction number included in the second request in response to receiving the second request.

According to yet another aspect of the present disclosure, the method further includes determining whether the second request is for reloading the card amount of the virtual debit card having the card number determined based on the unique transaction number, and adding a reload amount to the card amount of the virtual debit card having the card number determined based on the unique transaction number in response to determining that the second request is for reloading the card amount. In this regard, the reload amount is specified by the second request.

According to still another aspect of the present disclosure, the receipt consists essentially of the unique transaction number, the card number, the card amount, a security code, and an expiration date of the virtual debit card.

According to an additional aspect of the present disclosure, the method further includes assigning personal identity information to the virtual debit card after receiving the request for the virtual debit card, and transmitting the personal identity information of the virtual debit card to the terminal via the network. In this regard, the personal identity information is configured to be included on the receipt provided by the terminal.

According to another aspect of the present disclosure, the request specifies whether the virtual debit card is to be one of single-use and multi-use.

According to yet another aspect of the present disclosure, funds required for the virtual debit card are variable depending at least on whether the request specifies that the virtual debit card is to be the one of the single-use and the multi-use.

According to still another aspect of the present disclosure, the method further includes receiving funds from the terminal via the network with the request for the virtual debit card. The funds being at least equal to the card amount of the virtual debit card.

According to an additional aspect of the present disclosure, the method further includes forwarding the request for the virtual debit card to an issuing bank processor. In this regard, the issuing bank processor determines the card number of the virtual debit card, and the card number of the virtual debit card is received from the issuing bank processor when determining the card number of the virtual debit card.

According to another aspect of the present disclosure, the method further includes receiving a first unique transaction number from the issuing bank processor in association with the card number of the virtual debit card. A second unique transaction number is assigned to the request for the virtual debit card in response to receiving the first unique transaction number from the issuing bank processor. The second unique transaction number is stored in the memory in association with the first unique transaction number. The second unique transaction number is transmitted to the terminal via the network. The second unique transaction number is configured to be included on the receipt provided by the terminal along with the card number of the virtual debit card and is useable by the user for being anonymously associated with the virtual debit card.

According to another aspect of the present disclosure, the method further includes receiving funds from the terminal via the network with the request for the virtual debit card, with the funds being at least equal to the card amount of the virtual debit card. At least a portion of the funds is forwarded to one of the issuing bank processor and an issuing bank when forwarding the request for the virtual debit card to the issuing bank processor.

According to yet another aspect of the present disclosure, the method further includes receiving a pre-request for the virtual debit card from the user. A pre-request confirmation indicator is transmitted to the user after receiving the pre-request for the virtual debit card. The terminal transmits the request for the virtual debit card when the pre-request confirmation indicator and funds at least equal to the card amount are received by the terminal.

According to still another aspect of the present disclosure, the method further includes transmitting a promotional code to the terminal via the network with the card number of the virtual debit card, wherein the promotional code is configured to be included on the receipt provided by the terminal.

According to yet another aspect of the present disclosure, the method further includes receiving a promotional code from the terminal via the network. The promotional code is input at the terminal by the user and provides a benefit to the user.

According to an additional aspect of the present disclosure, the request for the virtual debit card is received from the terminal with the terminal being one of a retail register, an automated teller machine, and a kiosk.

According to another aspect of the present disclosure, the card number of the virtual debit card is configured to be unusable until a predetermined activation event is executed.

According to another non-limiting embodiment of the present disclosure, a terminal for processing a request for a virtual debit card is provided. The system includes an input configured to receive the request for the virtual debit card from a user. The request specifies a card amount of the virtual debit card. The system further includes a payment acceptor configured to accept funds at least equal to the card amount from the user and a transmitter configured to transmit the request for the virtual debit card to one of a merchant processor and an issuing bank processor in response to the payment acceptor receiving the funds. The request is anonymous with respect to the user. A receiver of the terminal is configured to receive at least a card number of the virtual debit card from the one of the merchant processor and the issuing bank processor, and a receipt provider is configured to provide a receipt to the user in response to the card number being received by the receiver from the one of the merchant processor and the issuing bank processor. The receipt includes at least the card number received by the receiver.

According to an aspect of the present disclosure, the input is configured to receive the request for the virtual debit card without receiving any personal identity information from the user.

According to another aspect of the present disclosure, the receiver is configured to receive the card number of the virtual debit card and the receipt provider is configured to provide the receipt to the user without associating the card number of the virtual debit card with the user.

According to yet another aspect of the present disclosure, the request for the virtual debit card that is transmitted by the transmitter to the one of the merchant processor and the issuing bank processor consists essentially of a terminal identifier for identifying the terminal and the card amount of the virtual debit card.

According to still another aspect of the present disclosure, the receiver is configured to receive a unique transaction number from the one of the merchant processor and the issuing bank processor when receiving the card number of the virtual debit card. The input is configured to receive a second request from the user for reloading the card amount of the virtual, wherein the second request includes a reload amount and the unique transaction number. The transmitter is configured to transmit the second request, without transmitting any personal identity information of the user, to the one of the merchant processor and the issuing bank processor in response to the input receiving the reload request. In this regard, the reload amount is added to the card amount of the virtual debit card in response to the transmitter transmitting the second request to the one of the merchant processor and the issuing bank processor.

According to an additional aspect of the present disclosure, the input includes a scanner configured to read a pre-request confirmation indicator that indicates the request for the virtual debit card from the user.

According to another aspect of the present disclosure, the input includes a biometric input configured to receive biometric data that indicates the request for the virtual debit card.

According to yet another non-limiting embodiment of the present disclosure, a system for processing a request for a virtual debit card is provided. The system includes a terminal configured to receive the request for the virtual debit card from a user and to transmit the request to a request processor. The request specifies a card amount of the virtual debit card and is anonymous with respect to the user of the terminal. The system further includes a request processor that is configured to receive the request for the virtual debit card from the terminal via a network, and determine at least a card number of the virtual debit card after receiving the request for the virtual debit card from the terminal. The card number of the virtual debit card is associated with the card amount of the virtual debit card. The request processor is further configured to transmit at least the card number of the virtual debit card to the terminal via the network, wherein the terminal is configured to receive the card number of the virtual debit card from the request processor and to provide a receipt to the user including the card number of the virtual debit card.

According to an aspect of the present disclosure, the terminal receives the request for the virtual debit card from the user without receiving any personal identity information from the user.

According to another aspect of the present disclosure, the terminal is configured to receive the card number of the virtual debit card from the request processor and to include the card number on the receipt without associating the card number with the user.

According to yet another aspect of the present disclosure, the request received by the request processor from the terminal consists essentially of a terminal identifier for identifying the terminal and the card amount of the virtual debit card.

According to still another aspect of the present disclosure, the request processor is further configured to assign a unique transaction number to the request for the virtual debit card in response to receiving the request for the virtual debit card from the terminal, store the unique transaction number in association with the card number of the virtual debit card, and transmit the unique transaction number to the terminal via the network. The terminal is further configured to include the unique transaction number on the receipt along with the card number of the virtual debit card.

According to an additional aspect of the present disclosure, the request bank processor is configured to receive a second request from the user via the network. The second request includes the unique transaction number and is non-identifying of the card number of the virtual debit card. The request processor is further configured to determine the card number of the virtual debit card based on the unique transaction number included in the second request in response to receiving the second request.

According to still another aspect of the present disclosure, the second request is anonymous with respect to the user.

According to another aspect of the present disclosure, the request processor is further configured to determine whether the second request is for reloading the card amount of the virtual debit card having the card number determined based on the unique transaction number, and add a reload amount to the card amount of the virtual debit card having the card number determined based on the unique transaction number in response to determining that the second request is for reloading the card amount. The reload amount is specified by the second request.

### BRIEF DESCRIPTION OF THE DRAWINGS

The present invention is further described in the detailed description which follows, in reference to the noted plurality of drawings, by way of non-limiting examples of preferred embodiments of the present invention, in which like characters represent like elements throughout the several views of the drawings.

FIG. 1 illustrates an exemplary system for processing a request for a virtual debit card.

FIG. 2 illustrates an exemplary schematic of a system for processing a request for a virtual debit card.

FIG. 3 illustrates an exemplary embodiment of a virtual debit card.

FIG. 4 illustrates an exemplary method of processing a request for a debit card.

FIG. 5 illustrates another schematic of a system for processing a request for a virtual debit card.

FIG. 6 illustrates a schematic of an exemplary loading funds process.

FIG. 7 illustrates a schematic of an exemplary clearing funds process.

### DETAILED DESCRIPTION

The present disclosure, through one or more of its various aspects, embodiments and/or specific features or sub-components, is thus intended to bring out one or more of the advantages as specifically noted below.

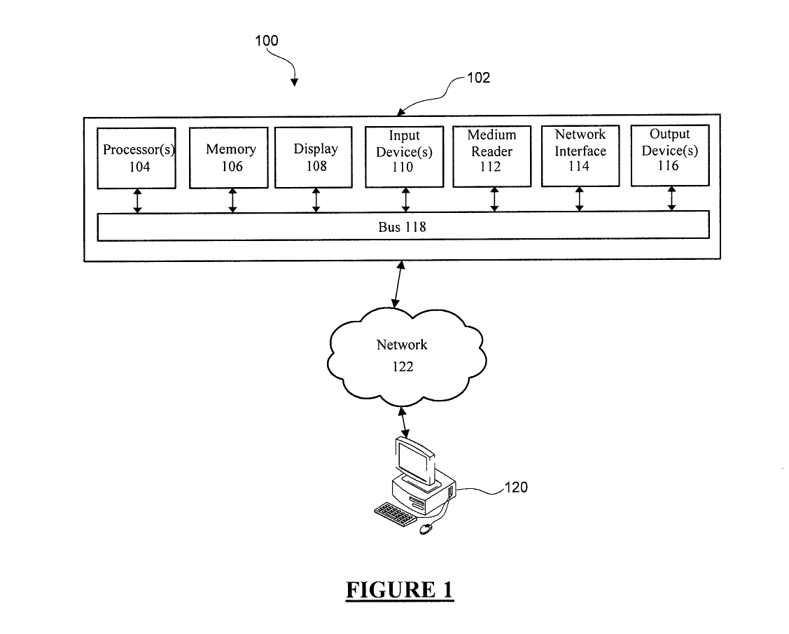

FIG. 1 is an exemplary system for use in accordance with the embodiments described herein. The system 100 is generally shown and may include a computer system 102, which is generally indicated. The computer system 102 may operate as a standalone device or may be connected to other systems or peripheral devices. For example, the computer system 102 may include, or be included within, any one or more computers, servers, systems, communication networks or cloud environment.

The computer system 102 may operate in the capacity of a server in a network environment, or the in the capacity of a client user computer in the network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that device. Further, while a single computer system 102 is illustrated, addition embodiments may include any collection of systems or sub-systems that individually or jointly execute instructions or perform functions.

As illustrated in FIG. 1, the computer system 102 may include at least one processor 104, such as, for example, a central processing unit, a graphics processing unit, or both. The computer system 102 may also include a computer memory 106. The computer memory 106 may include a static memory, a dynamic memory, or both. The computer memory 106 may additionally or alternatively include a hard disk, random access memory, a cache, or any combination thereof. Of course, those skilled in the art appreciate that the computer memory 106 may comprise any combination of known memories or a single storage.

As shown in FIG. 1, the computer system 102 may include a computer display 108, such as a liquid crystal display, an organic light emitting diode, a flat panel display, a solid state display, a cathode ray tube, a plasma display, or any other known display.

The computer system 102 may include at least one computer input device 110, such as a keyboard, a remote control device having a wireless keypad, a microphone coupled to a speech recognition engine, a camera such as a video camera or still camera, a cursor control device, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 and a network interface 114. Furthermore, the computer system 102 may include any additional devices, components, parts, peripherals, hardware, software or any combination thereof which are commonly known and understood as being included with or within a computer system, such as, but not limited to, an output device 116. The output device 116 may be, but is not limited to, a speaker, an audio out, a video out, a remote control output, a printer, or any combination thereof.

Each of the components of the computer system 102 may be interconnected and communicate via a bus 118. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, or any other network commonly known and understood in the art. The network 122 is shown in FIG. 1 as a wireless network. However, those skilled in the art appreciate that the network 122 may also be a wired network.

The additional computer device 120 is shown in FIG. 1 as a personal computer. However, those skilled in the art appreciate that, in alternative embodiments of the present application, the device 120 may be a laptop computer, a tablet PC, a personal digital assistant, a mobile device, a palmtop computer, a desktop computer, a communications device, a wireless telephone, a personal trusted device, a web appliance, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

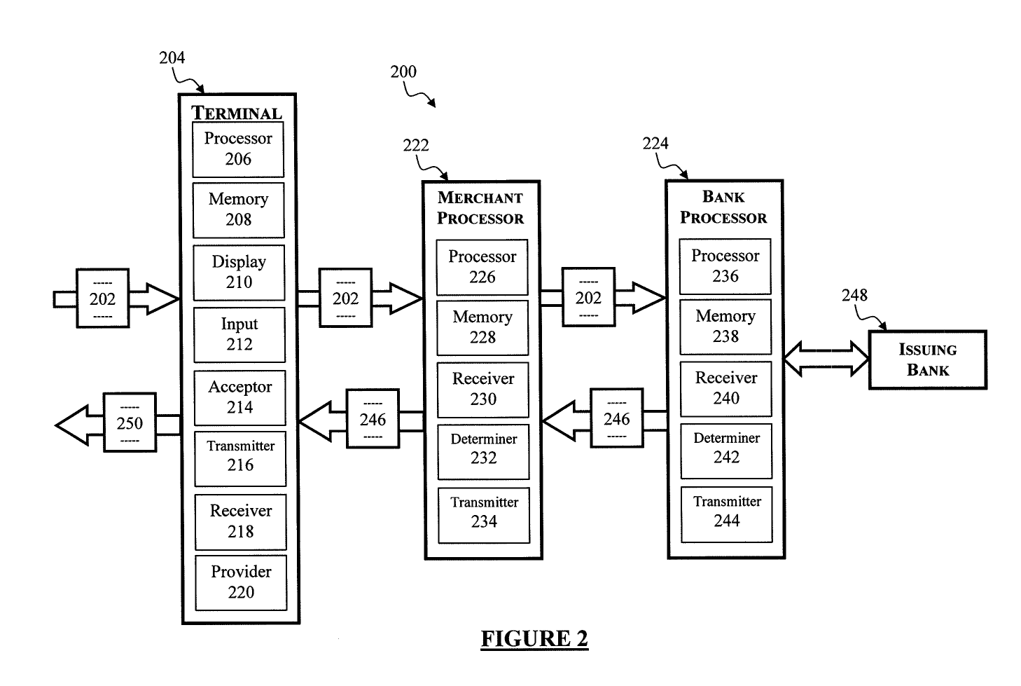

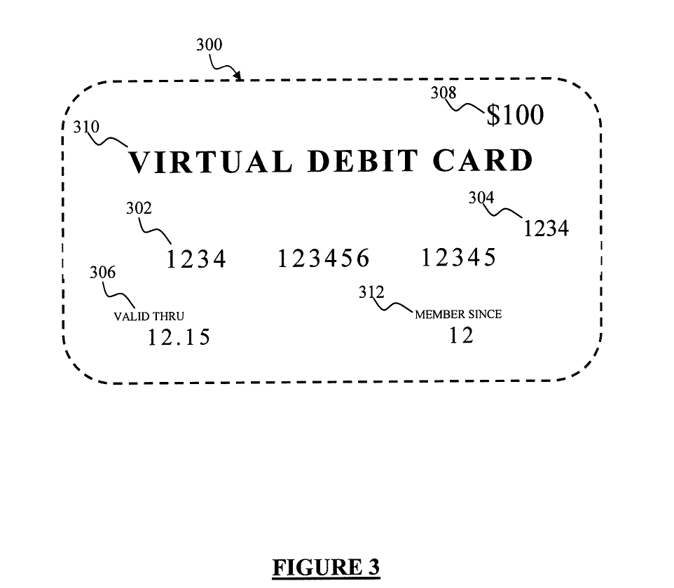

An exemplary schematic of a system for processing a request 202 for a virtual debit card 300 is generally shown at 200 in FIG. 2. A non-limiting and exemplary embodiment of the virtual debit card is generally indicated at 300 in FIG. 3.

In this regard, those skilled in the art appreciate that the virtual debit card 300 is shown in FIG. 3 for exemplary purposes and that the virtual debit card 300 may be issued without a corresponding physical card. Of course, those skilled in the art also appreciate that the virtual debit card 300 may be issued with a corresponding physical card in embodiments of the present disclosure.

The virtual debit card 300 at least includes a card number 302 for identifying an account associated with the virtual debit card 300. The card number 302 may comprise fifteen digits as shown in FIG. 3. However, in further embodiments of the present disclosure, the card number 302 may comprise any number of digits, such as, for example, sixteen. The card number 302 may also include any combination of characters, numbers, letters, and/or symbols in even further embodiments of the present disclosure.

The virtual debit card 300 may include a security code 304. The security code 304 may be a card verification value (CVV2), a card identification number (CID), a personal identification number (PIN), or any other security code generally known and understood in the art. In embodiments of the present application in which the virtual debit card 300 is associated with a physical card, the security code 304 may be printed on the front of the physical card as generally shown in FIG. 3. However, those skilled in the art appreciate that the security code 304 may be printed on the back of the physical card in further embodiments of the present application. In even further embodiments of the present application, the security code 304 may not be printed on the physical card.

The virtual debit card 300 may include an expiration date 306 and/or any additional information, such as, but not limited to, a card amount 308, a network brand 310, a membership identifier 312, or any combination thereof. Of course those skilled in the art appreciate that the above-listed examples are merely exemplary and are not meant to be limiting or exhaustive. In further embodiments of the present disclosure, the virtual debit card 300 may include additional or alternative data, such as a username (not shown).

In embodiments of the present disclosure, the virtual debit card 300 may be an open loop card or a closed loop card. An open loop card is a general purpose card that can be used wherever it is accepted, such as an American Express® card or a Visa® card. A closed loop card can only be used at a single store or merchant, of group of stores or merchants.

According to the system 200 as shown in FIG. 2, a terminal 204 is configured to receive the request 202 for the virtual debit card 300 from a user. The terminal 204 may comprise any computer system as generally described with respect to FIG. 1. In this regard, the terminal 204 is shown in FIG. 2 as including a processor 206, a memory 208, and a display 210. The processor 206, memory 208, and display 210 may be similar to, for example, the processor 104, the memory 106, and the display 108 as described with respect to FIG. 1.

The terminal 204 is also shown as including a payment acceptor 214, a transmitter 216, a receiver 218, and a receipt provider 220. In this regard, the transmitter 216 and the receiver 218 may be any network interface that is configured to receive and transmit network communications, such as, for example, the network interface 114 as described with respect to FIG. 1. The payment acceptor 214 may be any structure, device, or means that is configured to accept funds or payments which is known and understood in the art without departing from the scope of the present disclosure.

Moreover, the receipt provider 220 may also be any structure, device, or means that is configured to provide a receipt which is generally known and understood in the art without departing from the scope of the present disclosure. Of course, those skilled in the art appreciate that the terminal 204 is not limited to including the structures shown in FIG. 2. FIG. 2 is merely an exemplary embodiment of the present disclosure and, in additional embodiments of the present disclosure, the terminal 204 may include additional or alternative structures.

A single terminal 204 is shown in FIG. 2. However, those skilled in the art appreciate that the system 200 may comprise a plurality of terminals without departing from the scope of the present disclosure. The plurality of terminals may be configured to operate collectively or individually. In other words, the plurality of terminals may be linked via a network, such as described with respect to the network 122 of FIG. 1. Alternatively, each of the plurality of terminals may be configured to operate individually. The terminal 204 is described hereinafter in singular form. Nevertheless, those skilled in the art appreciate that the terminal 204 may comprise a plurality of terminals without departing from the scope of the present disclosure.

In non-limiting and exemplary embodiments of the present disclosure, the terminal 204 may be located in a retail location. The terminal 204 may be, for example, a retail register, an automated teller machine (ATM), or a kiosk. The kiosk may be a freestanding or fixed structure located in a retail environment, such as, for example, a shopping mall, a convenience store, a department store, etc. Of course those skilled in the art appreciate that the above-described examples are merely exemplary and are not meant to be limiting or exhaustive. For example, in additional embodiments of the present disclosure, the kiosk may be located along a public walkway or in the facade of a building.

The terminal 204 includes the input 212 which is configured to receive the request 202 for the virtual debit card 300 from the user. The request 202 specifies at least the card amount 308 of the virtual debit card 300. In this regard, the user may input the card amount 308 or the user may select the card amount 308 from a list of predetermined card amounts displayed on the display 210. In embodiments of the present disclosure, the request 202 may also include a specification or selection of whether the virtual debit card 300 is to be a single-use card or a multi-use card. In other words, the user may have the option to purchase a single-use or multi-use virtual debit card 300. The single-use card may be interpreted as being a single transaction card in which the entire card amount 308 must be spent in a single transaction or is lost. The multi-use card may be interpreted as being a multi-spend card in which the entire card balance may be used in multiple transactions. In this regard, both the single-use card and the multi-use card may be either reloadable or non-reloadable, and the request 202 may also include a specification or selection of whether the virtual debit card 300 is to be reloadable or non-reloadable. In additional or alternative embodiments of the present disclosure, the single-use card may be interpreted as being a non-reloadable card in which the card amount 308 is not able to be replenished in addition or alternatively to being interpreted as being a single transaction card in which the entire card amount 308 must be spent in a single transaction or is lost. In such embodiments, the request 202 need not specify whether the single-use card is reloadable or non-reloadable.

According to an embodiment of the present disclosure, the input 212 of the terminal 204 is configured to receive the request 202 for the virtual debit card 300 without receiving any personal identity information from the user. In other words, the terminal 204 anonymously receives the request 202 for the virtual debit card 300 from the user. The user is not required to establish an account with the terminal 204. As such, the virtual debit card 300 may be truly anonymous and safe since no personal data need be pre-stored or input with the request 202 for the virtual debit card 300. The personal identity information is any information which may identify the identity of a person, such as, for example, a name, an address, an email address, a telephone number, etc. In other words, the personal identity information is representative of a personal aspect or descriptive of the person. In embodiments of the present disclosure, the personal identity information does not include information which is only associated with a person for verification purposes, such as a personal identification number. Of course, those of ordinary skill in the art appreciate that in other embodiments of the present application, the personal identity information includes information which is associated with a person for verification purposes.

In embodiments of the present disclosure, the user may establish an account with the terminal 204. The account may include a name of the user, a telephone number, an email address, a physical address, a postal address, or any combination thereof. In such embodiments, a speed of the transaction may be improved. The account and personal identity information of the user may be stored in the memory 208 of the terminal 204. In additional embodiments of the present disclosure, the account and personal identity information may be stored in a central server (not shown) such that a plurality of terminals may each access the account and personal identity information of the user collectively.

In embodiments of the present disclosure, the input 212 of the terminal 204 may include a scanner configured to read a pre-request confirmation indicator that indicates the request 202 for the virtual debit card 300 from the user. The scanner may be, for example, a barcode scanner. In this regard, the request 202 for the virtual debit card 300 may be pre-requested or pre-staged. The user may access the central server or a website, or have previously accessed the terminal 204 or another terminal, and input a pre-request for the virtual debit card 300. The central server or the website, or the terminal 204 or another terminal, may provide the pre-request confirmation indicator, such as the barcode, to the user in response to receiving the pre-request.

The user may make the pre-request via any computing device, mobile application, or other means known and understood in the art, and the pre-request confirmation indicator may be provided to the user via phone, email, print, or any combination thereof or other means known in the art. Thereafter, the user may scan the pre-request confirmation indicator at the terminal 204 for inputting the request 202 for the virtual debit card 300 to the terminal 204. The pre-request confirmation indicator may indicate the card amount 308 for the virtual debit card 300, which may have been specified by the user at the time of making the pre-request. The user may be allowed to change or prohibited from changing the card amount 308 which was specified at the time of making the pre-request. In further embodiments, the user may not specify the card amount 308 for the virtual debit card 300 until after the terminal reads the pre-request confirmation indicator. The pre-request confirmation indicator may improve a speed of the transaction at the terminal 204. Of course, those skilled in the art appreciate that additional or alternative pre-request confirmation indicators may be used additionally or alternatively to the barcode. For example, in embodiments of the present disclosure, the pre-request confirmation indicator may be a Quick Response (QR) code or alphanumeric code. The above-listed pre-request confirmation indicators are merely exemplary and are not meant to be limiting or exhaustive.

In additional embodiments of the present disclosure, the input 212 of the terminal 204 may include a biometric input configured to receive biometric data that indicates the request 202 for the virtual debit card 300. For example, the input 212 of the terminal 204 may include a voice recognition system, iris recognition system, fingerprint scanner, or any other biometric data receiver known and understood in the art. The request 202 for the virtual debit card 300 may be made via the biometric input without the biometric data being stored by the terminal 204 or associated with the user. For example, the input of the terminal 204 may be voice activated for receiving an audible request for the virtual debit card 300. In further embodiments of the present disclosure, the terminal 204 may link the biometric data with the user, such as by storing the biometric data in the memory 208 or the central server in association with the user. For example, the terminal 204 may store the biometric data in an account associated with the user so that the user may be recognized in subsequent transactions. The terminal 204, itself, may store the biometric data, or, in further embodiments, the central server may store the biometric data such that the user may be recognized at a plurality of terminals. The biometric data may be stored to both improve speed and for added security.

The terminal 204 includes the payment acceptor 214 which is configured to accept funds or payment at least equal to the card amount 308 of the request 202 for the virtual debit card 300 from the user. The payment acceptor may be, for example, a cash acceptor, credit card reader, or any combination thereof. Of course, those skilled in the art appreciate that the above-described examples are merely exemplary and are not meant to be limiting or exhaustive. For example, in further embodiments of the present disclosure, the payment acceptor 214 may be a contactless payment system that reads a radio frequency identification device. The payment acceptor 214 may also include a cash dispenser for dispensing change.

As discussed above, the payment acceptor 214 of the terminal 204 is configured to accept funds at least equal to the card amount 308 of the request 202 for the virtual debit card 300 from the user. In this regard, in embodiments of the present disclosure, the payment acceptor 214 may be configured to accept funds equal to a sum of the card amount 308 and a service fee. The service fee may be determined based on the card amount 308. In additional or alternative embodiments, the service fee may be determined based on a frequency or number of the request 202 for the virtual debit card 300 which is input by the user. The service fee may also be based on whether the request 202 is for a single-use or multi-use virtual debit card 300. For example, a $100 single-use virtual debit card 300 may be priced less than a $100 multi-use virtual debit card 300.

In an embodiment of the system 200 of FIG. 2, the payment acceptor 214 of the terminal 204 is configured to accept the funds or payment when the request 202 for the virtual debit card 300 is received by the input 212 of the terminal 204. In other words, prefunding is not required and funding or payment may be at the time of the request 202 for the virtual debit card 300 or at the time of issuance of the virtual debit card 300 The funding or payment may be by cash, check, credit card, mobile wallet, or debit of an account. Prefunding, however, may be provided in embodiments of the present disclosure in which an account is associated with the user.

The terminal 204 includes the transmitter 216, such as described with respect to the network interface 114 of FIG. 1, for example, which is configured to transmit the request 202 for the virtual debit card 300 to a request processor in response to the payment acceptor 214 receiving the funds. The request processor may be a merchant processor 222 or an issuing bank processor 224.

The merchant processor 222 is a payment processor which provides a point of connectivity to a merchant for authorizing and settling transactions. The merchant processor 222 is shown in FIG. 2 as including a processor 226, a memory 228, a receiver 230, a determiner 232, and a transmitter 234. The processor 226, the memory 228, the receiver 230, and the transmitter 234 may be similar to, for example, the processor 104, the memory 106, and the network interface 114 as described with respect to FIG. 1. The determiner 232 may be any device, structure, or means that is configured to determine the card number 302 of the virtual debit card 300 which is generally known and understood in the art without departing from the scope of the invention. The determiner 232, itself, may determine the card number 302 of the virtual debit card 300, or the determiner 232 may determine the card number 302 of the virtual debit card 300 via any external or internal structure, device, or means, or combination thereof. Of course, those skilled in the art appreciate that the merchant processor 222 may include additional or alternative structures in additional embodiments of the present disclosure.

In embodiments of the present disclosure, the issuing bank processor 224 may be a financial institution which handles acceptance and payment of financial transactions. In further embodiments, the issuing bank processor 224 may be a commercial or business entity which acts independently or on behalf of an issuing bank 248. The issuing bank processor 224 is also shown in FIG. 2 as including a processor 236, a memory 238, a receiver 240, a determiner 242, and a transmitter 244. The processor 236, the memory 238, the receiver 240, and the transmitter 244 may be similar to, for example, the processor 104, the memory 106, and the network interface 114 as described with respect to FIG. 1. The determiner 242 may be any device, structure, or means that is configured to determine the card number 302 of the virtual debit card 300 which is generally known and understood in the art without departing from the scope of the invention. The determiner 242, itself, may determine the card number 302 of the virtual debit card 300, or the determiner 242 may determine the card number 302 of the virtual debit card 300 via any external or internal structure, device, or means, or combination thereof. Of course, those skilled in the art appreciate that the merchant processor 222 may include additional or alternative structures in additional embodiments of the present disclosure.

In the system 200 as shown in FIG. 2, the terminal 204 is shown as transmitting the request 202 for the virtual debit card 300 to the merchant processor 222. However, those skilled in the art appreciate that the request 202 may be transmitted directly to the issuing bank processor 224 in additional embodiments of the present disclosure.

In an embodiment of the present disclosure as shown in FIG. 2 in which the terminal 204 transmits the request 202 for the virtual debit card 300 to the merchant processor 222, the merchant processor 222 may transmit the request 202 to the issuing bank processor 224 for determining the card number 246 of the virtual debit card 300. In other words, the merchant processor 222 may determine the card number 246 of the virtual debit card 300 by requesting the issuing bank processor 224 to determine the card number 246.

The request 202 for the virtual debit card 300 that is transmitted from the terminal 204 to the merchant processor 222 and/or the issuing bank processor 224 is anonymous with respect to the user that initiated the request 202. The request 202 does not include any personal identity information, such as a name, address, social security number, telephone number, birth date, email address, etc., of the user. Even a generic address, such as a zip code, is not provided by the request 202. Instead, “personal” identity information may be determined and provided by either the merchant processor 222 or the issuing bank processor 224. The merchant processor 222 or the issuing bank processor 224 may determine and provide a name, an address, or both to the virtual debit card 300. The address may be a full address, including a street address, city or town, state, and zip code, or the address may be a generic address, such as a zip code. The “personal” information that is provided by the merchant processor 222 or the issuing bank processor 224 may be associated with the virtual debit card 300. According to such embodiments, the virtual debit card 300 may be used even when credit or debit card processors look to validate the card number, such as by requiring a name and/or address.

In an embodiment of the present disclosure, the request 202 consists essentially of a terminal identifier for identifying the terminal 204 and the card amount 308 of the virtual debit card 300. In this regard, in embodiments of the present disclosure in which the merchant processor 222 or the issuing bank processor 224 provides “personal” identity information, the “personal” identity information may be randomly determined or may be determined in accordance with any known information. For example, in an embodiment of the present disclosure in which the merchant processor 222 or the issuing bank processor 224 determines the zip code, the merchant processor 222 or the issuing bank processor 224 may determine the zip code based on a location of the terminal 204, the terminal 204 and the location of the terminal 204 being determined in accordance with the terminal identifier. In alternative embodiments of the present disclosure, the merchant processor 222 or issuing bank processor 224 may randomly determine the zip code or determine the zip code in accordance with any other means. In this regard, associating a zip code with the virtual debit card 300 may enhance security and usefulness of the virtual debit card 300, such as, for example, if a retailer or merchant requires a zip code for verification or authentication.

The request processor is configured to receive the request 202 for the virtual debit card 300 from the terminal 204, directly or indirectly, via a network (not shown). The request processor is further configured to determine at least the card number 302 of the virtual debit card 300 after receiving the request 202 for the virtual debit card 300, directly or indirectly, from the terminal 204. The request processor, itself, may determine the card number 302 of the virtual debit card 300, or, in additional or alternative embodiments, the request processor may determine the card number 302 of the virtual debit card 300 via an issuing bank 248. The issuing bank 248 is a financial institution that generally issues credit cards to individuals for use.

In this regard, in the system 200 shown in FIG. 2, the request 202 for the card number 302 of the virtual debit card 300 is transmitted from the terminal 204 to the merchant processor 222. The merchant processor 222 transmits the request 202 to the issuing bank processor 224. Thereafter, the issuing bank processor 224 may transmit the request 202 to the issuing bank 248, whereupon the issuing bank 248 determines the card number 302 of the virtual debit card 300. Of course, those skilled in the art appreciate that in further embodiments the issuing bank processor 224 may determine the card number 302 of the virtual debit card, or that the issuing bank processor 224 and the issuing bank 248 may be the same entity. In this regard, according to an embodiment of the present disclosure, the request processor may be the merchant processor 222. The merchant processor 222 directly receives the request 202 for the card number 302 of the virtual debit card 300 from the terminal 204, and indirectly determines the card number 302 of the virtual debit card 300 via the issuing bank processor 224 and/or the issuing bank 248.

In another embodiment of the present disclosure, the request processor may be the issuing bank processor 224. The issuing bank processor 224 indirectly receives the request 202 for the card number 302 of the virtual debit card 300 from the terminal 204 via the merchant processor 222, and determines the card number 302 of the virtual debit card 300 via the issuing bank processor 224. In an even further embodiment of the present application, the issuing bank processor 224 may receive the request 202 for the card number 302 of the virtual debit card 300 directly from the terminal 204, and determine the card number 302 of the virtual debit card 300 via the issuing bank 248.

In addition to determining the card number 302 of the virtual debit card 300, the request processor may also determine a security code 304 and an expiration date 306 of the virtual debit card 300 after receiving the request 202 for the virtual debit card 300 from the terminal 204. The request processor, itself, may determine the security code 304 and the expiration date 306 of the virtual debit card 300, or, in additional or alternative embodiments, the request processor may determine the security code 304 and the expiration date 306 via the issuing bank 248. Of course, those skilled in the art appreciate that the request processor may determine additional information of the virtual debit card 300 after receiving the request 202 for the virtual debit card 300 from the terminal 204, such as, for example, the membership identifier 312 as shown in FIG. 3. Moreover, as discussed above, the request processor may also determine a zip code in association with the card number 302 of the virtual debit card 300.

After determining the card number 302 of the virtual debit card 300, the merchant processor 222, the issuing bank processor 224, the issuing bank 248, or any combination thereof stores the card amount 308 in association with the card number 302. Any purchases, debits, or transfers made by the card number 302 reduce the card amount 308 of the card number 302 accordingly. The security code 304, the expiration date 306, and the zip code may also be stored in association with the card number 302 and the card amount 308 of the virtual debit card 300.

In addition to the above, the request processor, such as the merchant processor 222 or the issuing bank processor 224, is further configured to assign a unique transaction number (UTN) to the request 202 for the virtual debit card 300. In this regard, while the request 202 for the virtual debit card 300 does not include any personal identity information of the user that made the request 202, the user, or request 202, may be identified by the unique transaction number. For example, if the unique transaction number is assigned to the request 202 and provided to the user by the request processor after the request processor receives the request 202, the user may identify himself or herself to the request processor by providing the unique transaction number to the request processor without having to provide the card number 302 resulting from the request 202. The advantage of the unique transaction number is that, in follow up communications with the user, the card number 246 itself does not have to be exposed. This provides additional fraud and security protection as well as making it easier for the request processor to provide user support without being Payment Card Industry Data Security Standard compliant.

The request processor, being the merchant processor 222 or the issuing bank processor 224, may assign the unique transaction number to the request 202 in response to receiving the request 202, directly or indirectly, from the terminal 204. In this regard, the unique transaction number may be provided to the user such that the user may contact the request processor even when the request 202 for the virtual debit card 300 is declined. In additional embodiments of the present disclosure, the request processor may assign the unique transaction number to the request 202 for the virtual debit card 300 upon determining the card number 302. The unique transaction number may be stored by the request processor in association with the card number 302 such that the card number 302 may be determined in response to the user providing the unique transaction number.

In embodiments of the present disclosure in which the merchant processor 222 transmits the request 202 for the virtual debit card 300 to the issuing bank processor 224 or the issuing bank 248, the issuing bank processor 224 or the issuing bank 248 may assign a first unique transaction number to the request 202. Thereafter, the issuing bank processor 224 or the issuing bank 248 may transmit the first unique transaction number to the merchant processor 222. The merchant processor 222 may assign a second unique transaction number to the request 202, and the second unique transaction number is the actual unique transaction number that is provided to the user. As a result, the first unique transaction number, which is assigned by the issuing bank processor 224 or the issuing bank 248 is hidden from the user. This adds a double layer of Payment Card Industry compliance protection and a double layer of hacker protection. In future correspondences between the user and the merchant processor 222, the user may provide the second unique transaction number to the merchant processor 222. The merchant processor 222 may match the second unique transaction number with the first unique transaction number assigned by the issuing bank processor 224 or the issuing bank 248, and pass the first unique transaction number to the issuing bank processor 224 or the issuing bank 248 for validation. The user my only receive access to his or her virtual debit card 300 activity when the second unique transaction number matches the first unique transaction number.

After determining the card number 302 of the virtual debit card 300, the request processor, such as the merchant processor 222 or the issuing bank processor 224, is configured to transmit at least the card number 246 of the virtual debit card 300 to the terminal 204 via the network, directly or indirectly. The request processor may also transmit the security code 304, the expiration date 306, the unique transaction number, any additional information, or any combination thereof to the user along with the card number 302 of the virtual debit card 300.

The terminal 204 is configured to include the card number 302 of the virtual debit card 300 on a receipt 250. The card number 302 that is included on the receipt 250 may be immediately active and useable, or, in additional embodiments, the card number 302 that is included on the receipt 250 may be inactive and unusable until a predetermined activation event is executed. The predetermined activation event may be, for example, calling the issuing bank processor 224 or the issuing bank 248. In additional or alternative embodiments of the present application, the predetermined activation event may include waiting a predetermined time period or providing activation information. The activation information may be personal identification information that is associated with the user, or the activation information may be anonymous with respect to the user. For example, the activation information may be a password or identification number that is received by the user in response to the pre-request. In an embodiment of the present application in which the card number 302 that is included on the receipt 250 is for a replacement card, the activation information may be the card number of the replaced virtual debit card or the unique transaction number that is associated with the replaced virtual debit card. Of course, the above-described examples are not meant to be limiting or exhaustive. Those skilled in the art appreciate that any known activation events or methods of activating a stored value, debit, or credit card may be used without departing from the scope of the present application.

In the event that the terminal 204 receives the security code 304, the expiration date 306, the zip code, the unique transaction number, any additional information, or any combination thereof along with the card number 302 of the virtual debit card 300, the terminal 204 may be configured to also provide this information on the receipt 250.

The receiver 218 of the terminal 204 is configured to receive at least the card number 246 from the request processor, such as the merchant processor 222 or the issuing bank processor 224. The receipt provider 220 of the terminal 204 is configured to provide the receipt 250 to the user in response to at least the card number 246 being received by the receiver 218 from the request processor. The receipt provider 220 may include the card number 302 of the virtual debit card 300 as well as other standard card information, such as the security code 304 and the expiration date 306, on the receipt 250. The receipt provider 220 may also include the zip code and the unique transaction number on the receipt 250. The receipt provider 220 may print a paper receipt for the user, send an email message including the receipt 250 to the user, send a text message including the receipt 250 to the user, or provide the receipt 250 via a mobile application. Of course, those skilled in the art appreciate that the above-listed examples are merely exemplary and are not meant to be limiting or exhaustive.

The receipt provider 220 is configured to provide the receipt 250 to the user in response to at least the card number 246 being received by the receiver 218 from the one of the issuing bank processor 224 and the issuing bank 248. In additional embodiments of the present disclosure, the receipt 250 may be provided to the user by the merchant processor 222 or by any merchant or establishment in which, or near which, the terminal is located.

The receipt 250 includes at least the card number 302 of the virtual debit card 300 that is received by the receiver 218. In an embodiment of the present disclosure, however, the receiver 218 of the terminal 204 is configured to receive at least the card number 246 and the receipt provider 220 of the terminal 204 is configured to provide the receipt 250 to the user without associating the card number 302 of the virtual debit card 300 with the user. That is, the terminal 200 provides the card number 302 of the virtual debit card 300 to the user without associating any personal identity information of the user with the card number 302 or without printing any personal identity information of the user on the receipt 250. Accordingly, the virtual debit card 300 is truly anonymous and safe since no personal identification information is stored or associated with the virtual debit card 300. Instead, the user is merely provided with a receipt 250 that includes the card number 302 of the virtual debit card 300, and any other information related only to the virtual debit card 300.

In the embodiment of the present disclosure in which the receipt 250 that is provided to the user includes the unique identification number, the input 212 of the terminal 204 is configured to receive a second request from the user via the network. The second request includes the unique transaction number and is anonymous with respect to the user and non-identifying of the card number 302 of the virtual debit card 300. In other words, the second request does not include any personal identity information of the user and does not disclose or mention the card number 302 of the virtual debit card 300.

The transmitter 216 of the terminal 204 is configured to transmit the second request to the request processor, such as the merchant processor 222 or the issuing bank processor 224. The second request includes the unique transaction number and is transmitted from the terminal 204 and received by the request processor without including any personal identity information of the user. As such, the second request is also anonymous to the user. The request processor is configured to determine the card number 302 of the virtual debit card 300 based on the unique transaction number included in the second request in response to receiving the second request. As such, the request processor is able to determine the card number 302 without the card number 302 being disclosed or transmitted via the network and without any personal identity information of the user being disclosed or transmitted.

The request processor may be configured to determine whether the second request is for reloading the card amount 308 of the virtual debit card 300 having the card number 302 determined based on the unique transaction number. When the second request is for reloading the card amount 308 of the virtual debit card 300, the request processor may be further configured to add a reload amount to the card amount 308 of the virtual debit card 300 having the card number 302 determined based on the unique transaction number in response to determining that the second request is for reloading the card amount 308. The reload amount may be specified by the second request or may be a predetermined amount. For example, if the user has associated an account with the card number 302, the user may have updated his or her preferences to reload a specific, predetermined amount. In this regard, a unique transaction number may be associated with each reload request of the virtual debit card 300. According to such an embodiment, the virtual debit card 300 may only be reloaded by revealing the original unique transaction number. In other words, the request processor may be configured to determine whether the second request includes the original unique transaction number associated with the card number 302 or a subsequent unique transaction number associated with the card number 302. The request processor may be configured to reload the card amount 308 only when the second request includes the original unique transaction number.

The request processor may also be configured to determine whether the second request is for converting the virtual debit card 300 from a single-use card to a multi-use card. As previously discussed, the single-use card may be interpreted as being a single transaction card in which the entire card amount 308 must be spent in a single transaction or is lost. In this regard, the single-use card may be converted into a multi-spend card in which the entire card balance may be used in multiple transactions. According to such embodiments, the request processor may also be configured to determine whether the second request is for converting the virtual debit card 300 from a non-reloadable card to a reloadable card. Both the single transaction card and the multi-spend card may be non-reloadable cards and both may be converted to reloadable cards, or vice versa.

In additional or alternative embodiments of the present disclosure, the single-use card may be interpreted as being a non-reloadable card in which the card amount 308 is not able to be replenished. According to such embodiments, the request processor may be configured to determine whether the second request is for converting the virtual debit card 300 from the non-reloadable card into a reloadable card in which the card amount 308 is able to be replenished. Of course, the request processor may also be configured to determine whether the second request is for converting the virtual debit card 300 from the reloadable card into the non-reloadable card.

When the request processor determines that the second request is for converting the virtual debit card 300 from a single-use card to a multi-use card, the request processor is configured to convert the virtual debit card 300 accordingly. For example, the request processor may convert the single-use card into a multi-spend card. Additionally, or alternatively, the request processor may convert the single-use card, for example, the single transaction card or the non-reloadable multi-spend card, into a reloadable card. Of course, those skilled in the art appreciate that service fees may apply to requests for reloading the card amount 308 and for converting the virtual debit card 300 from a single-use card to a multi-use card. A service fee may also apply to a request for providing a physical debit card in association with the virtual debit card 300.

Thus, according to embodiments of the present disclosure, the virtual debit card 300 is reloadable and in essence uniquely convertible from a single-use card to a multi-use card. The reload can be done via the web, mobile, cash at retail, etc. The processor 206 of the terminal 204 or the central server can control all aspects of the reload including the number of times reloaded, the dollar amounts, where and how it is reloaded, etc. In additional embodiments of the present disclosure, the request processor may control all aspects of the reload including the number of times reloaded, the dollar amounts, where and how it is reloaded, etc. Of course, those skilled in the art appreciate that the above-listed aspects of the reload are merely exemplary and are not meant to be limiting or exhaustive.

In certain embodiments of the present disclosure, the terminal 204 or the request processor may request that the user convert the virtual debit card 300 to a reloadable plastic card. The reloadable plastic card functions as a common general purpose reloadable debit card. The conversion aspect can be accomplished by an anonymous purchase, as described above with respect to the request 202 for the card number 302, and a subsequent registration via the web, interactive voice response application, or on the phone to the request processor. The registration may be done by only passing the unique transaction number to the request processor. In this regard, the request processor may require the original unique transaction number associated with the card number 302 of the virtual debit card 300, or may require any unique transaction number associated with the card number 302 of the virtual debit card 300. When converting the virtual debit card 300 to the reloadable plastic card, the user may be required to provide personal identity information, such as, but not limited to, a name, social security number, birth date, and address to enable the card to be reloadable.

A balance or history of the virtual debit card 300 may be checked by the user in real-time by inputting the original unique transaction number, or any unique transaction number, to the terminal 204. Moreover, according to embodiments of the present disclosure, the balance or history of the virtual debit card 300 may be checked or monitored by entering the original unique transaction number or any unique transaction number at a website, such as, for example, a website of the request processor. Moreover, in further embodiments, refunds may be done via the website to make the process from the user's perspective totally automated. This speeds and simplifies the process.

In even further embodiments, an extra layer of security may be added to the virtual debit card 300 by the user personally associating personal identity information with the virtual debit card 300. For example, the user may register herself or himself in association with the card number 300 of the virtual debit card 300. In this regard, the user may be provided with notifications and updates for each purchase, debit, advance, or transfer. The updates may be provided to the user on, for example, a mobile device or via email.

In additional embodiments of the system 200, the receipt provider 220 may include a promotional code on the receipt 250. The promotional code may be determined by the terminal 204 or may be received by the terminal 204 from the request processor via the network along with the card number 246 of the virtual debit card 300. In this regard, the promotional code may be tagged to a purchase of the virtual debit card 300 online or at the terminal 204 so that partners, such as charities, can participate in rebates, or so that the user receives a loyalty tie in.

In further embodiments of the system 200, the promotional code may additionally or alternatively be provided to the terminal 204 by the user. The user may have been made aware of the promotional code by an external source, such as an advertisement, an organization, or another user. The user may provide the promotional code to the terminal 204 when requesting the virtual debit card 300, whereupon the user may receive a discount of a purchase fee or any other benefit. In this regard, the promotional code that is provided to the terminal 204 may be linked to the external source so that a benefit may also be provided to the external source.

According to an embodiment of the system 200, the virtual debit card 300 may be used by a user as a bill payment source. The user may request a new virtual debit card 300 or use an existing virtual debit card 300 as the bill payment source. At the terminal or online or via any alternative medium, the user may request the request processor to pay a bill. The request processor debits funds from the user's virtual debit card, and transmits the funds to an issuer of the bill. According to such an embodiment, the user is able to indirectly pay the bill via the request processor. This enables the user and the virtual debit card to remain anonymous to the issuer of the bill.

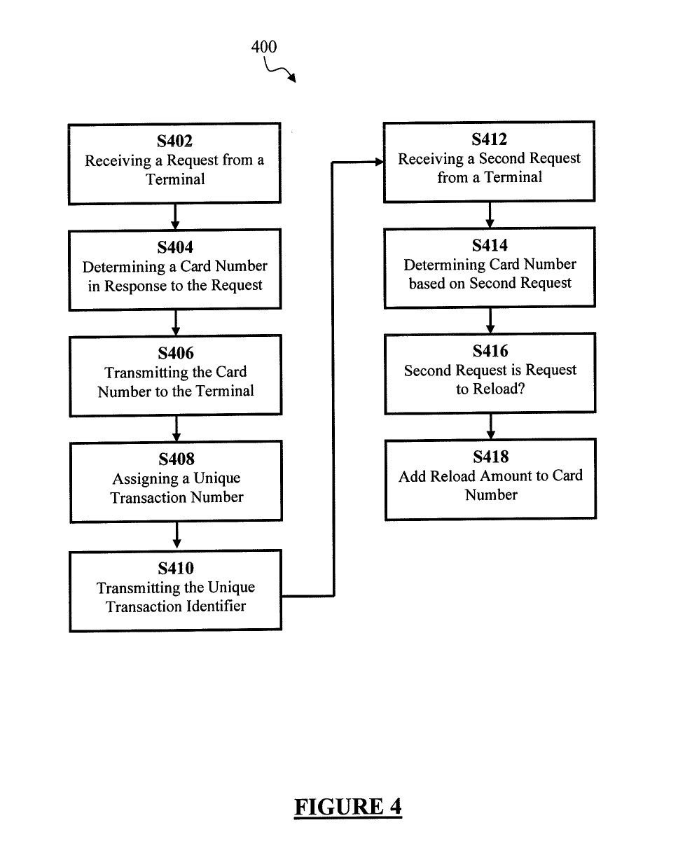

The present disclosure further provides various methods for processing a request for a virtual debit card. Those skilled in the art appreciate, of course, that the various methods may be implemented in accordance with the teachings and disclosure discussed above. FIG. 4 of the present disclosure shows an exemplary embodiment of a method for processing a request for a virtual debit card. The method is generally indicated at 400.

According to the method 400, a request processor receives the request for the virtual debit card from a terminal via a network at S402. The request specifies a card amount of the virtual debit card and is anonymous with respect to a user of the terminal. The method determines at least a card number of the virtual debit card after receiving the request for the virtual debit card from the terminal at S404. The card number of the virtual debit card is stored in a memory in association with the card amount of the virtual debit card. At least the card number of the virtual debit card is transmitted from the request processor to the terminal via the network at S406. The card number is configured to be included on a receipt provided by the terminal to the user.

The method 400 further assigns a unique transaction number to the request for the virtual debit card in response to receiving the request for the virtual debit card from the terminal at S408. The unique transaction number is stored in the memory in association with the card number of the virtual debit card. The unique transaction number is transmitted to the terminal via the network at S410. The unique transaction number is configured to be included on the receipt provided by the terminal along with the card number of the virtual debit card.

Thereafter, the method 400 receives a second request from the user via the network at S412. The second request includes the unique transaction number and is anonymous with respect to the user and non-identifying of the card number of the virtual debit card. The card number of the virtual debit card is determined based on the unique transaction number included in the second request in response to receiving the second request at S414. Then, it is determined whether the second request is for reloading the card amount of the virtual debit card having the card number determined based on the unique transaction number at S416. A reload amount is added to the card amount of the virtual debit card having the card number determined based on the unique transaction number in response to determining that the second request is for reloading the card amount at S418. The reload amount is specified by the second request.

Of course, those skilled in the art appreciate that the above-described method 400 is merely exemplary and that the present disclosure includes various additional and alternative methods in accordance with the teachings and disclosure set forth herein.

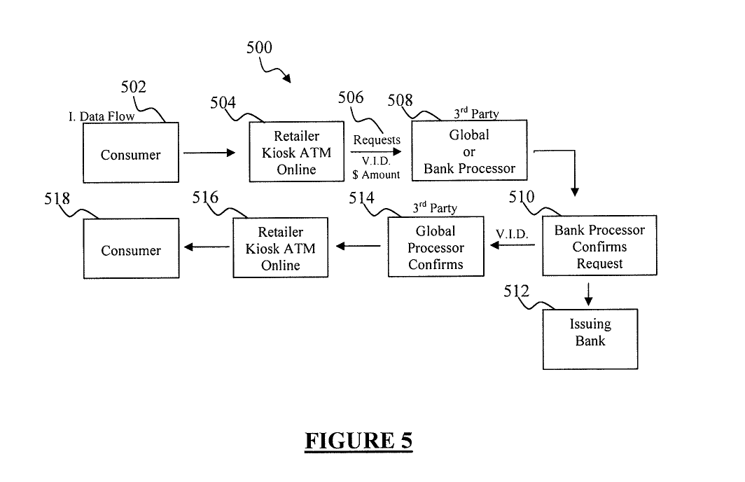

A non-limiting and exemplary schematic of an embodiment for processing a request for a virtual debit card is generally shown at 500 in FIG. 5. According to FIG. 5, a customer 502 walks into a retail location 504 and requests a virtual debit card or any instant prepaid debit card (VID card) for any particular amount. The request 506 is sent to a processing company 508 through a computer system. The processing company 508 sends the request 506 to an issuing bank processor 510 which issues virtual debit cards or instant prepaid debit cards using an issuing bank 512. The request 506 could be made directly to the issuing bank processor 510, but having a processing company provides more controls, regulatory compliance, etc. The virtual debit card or instant prepaid card is transmitted from the issuing bank processor 510 to the processing company 514, and then to the retail location 516, and finally to the customer 518. The customer gets the virtual debit card or the instant prepaid debit card with all information printed on a receipt, sent to a mobile device, and/or sent to an email address. The receipt may include a security code, an expiration date, and maybe even a standard address zip code and unique transaction code in order to make “card not present” transactions. The receipt may also include other personal information of the user, such as, but not limited to, a name, username, account number, personal address, payment source, or any combination thereof. As shown in FIG. 5, the customer request can also be made at a kiosk, ATM or even online if payment is made via credit card, mobile wallet, or bank account debit. The virtual debit card or prepaid instant debit card can be a one time only use by the customer or a multiuse whereby each transaction amount is deducted from the remaining balance.

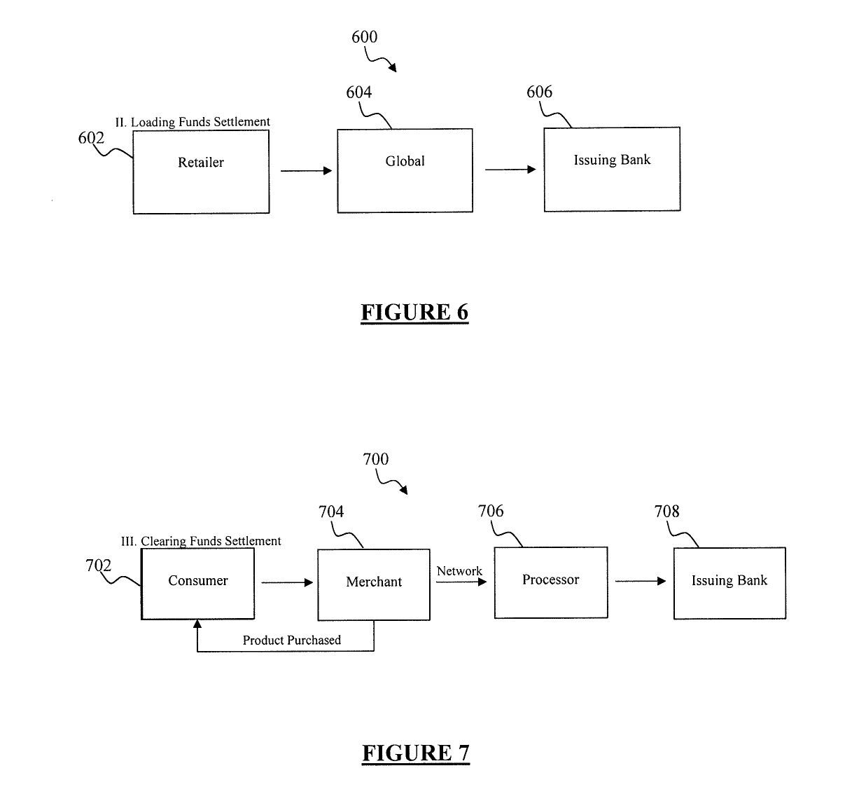

FIG. 6 of the present disclosure generally indicates an exemplary loading funds settlement process at 600. In this regard, a user provides funds or payment for a virtual debit card to a retailer or a terminal 602. The retailer or the terminal 602 provides the funds or payment to a global processor 604, and the global processor 604 provides the funds to an issuing bank 606.

FIG. 7 of the present disclosure generally indicates an exemplary clearing funds settlement process at 700. In this regard, a consumer 702 requests a virtual debit card and provides funds or payment to a merchant 704. The merchant 704 transmits the request for the virtual debit card and the funds or payment to a request processor 706. The request processor transmits the request for the virtual debit card and the funds or payment to an issuing bank 708. FIG. 7 shows the request processor as transmitting the request for the virtual debit card to the issuing bank 708. However, those skilled in the art appreciate that the request processor may transmit the request to an issuing bank processor in additional embodiments. When the funds or payment clear, the issuing bank 708 authorizes the request for the virtual debit card and the merchant 704 provides the virtual debit card to the customer 702.

Accordingly, the present invention provides various systems, servers, methods, media, and programs for processing a request for a virtual debit card. Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

While the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for processing a request for a virtual debit card, comprising:
receiving the request for the virtual debit card from a terminal via a network, the request specifying a card amount of the virtual debit card and being anonymous with respect to a user of the terminal;
determining at least a card number of the virtual debit card after receiving the request for the virtual debit card from the terminal, the card number of the virtual debit card being stored in a memory in association with the card amount of the virtual debit card; and
transmitting at least the card number of the virtual debit card to the terminal via the network,
wherein the card number is configured to be included on a receipt provided by the terminal to the user.

2. The method according to claim 1, wherein the request for the virtual debit card is received from the terminal without the terminal receiving any personal identity information from the user of the terminal.

3. The method according to claim 1, wherein the card number of the virtual debit card that is configured to be included on the receipt is configured to be provided to the user by the terminal without the card number being associated with the user by the terminal.

4. The method according to claim 1, wherein the request consists essentially of a terminal identifier for identifying the terminal and the card amount of the virtual debit card.

5. The method according to claim 1, further comprising:
determining a security code and an expiration date of the virtual debit card after receiving the request for the virtual debit card from the terminal, the security code and the expiration date being stored in the memory in association with the card number and the card amount of the virtual debit card; and
transmitting the security code and the expiration date of the virtual debit card to the terminal via the network,
wherein the security code and the expiration code are configured to be included on the receipt provided by the terminal.

6. The method according to claim 1, further comprising:
assigning a unique transaction number to the request for the virtual debit card in response to receiving the request for the virtual debit card from the terminal, the unique transaction number being stored in the memory in association with the card number of the virtual debit card; and
transmitting the unique transaction number to the terminal via the network,
wherein the unique transaction number is configured to be included on the receipt provided by the terminal along with the card number of the virtual debit card.

7. The method according to claim 6, further comprising:
receiving a second request from the user via the network, the second request including the unique transaction number and being anonymous with respect to the user and non-identifying of the card number of the virtual debit card; and
determining the card number of the virtual debit card based on the unique transaction number included in the second request in response to receiving the second request.

8. The method according to claim 7, further comprising:
determining whether the second request is for reloading the card amount of the virtual debit card having the card number determined based on the unique transaction number; and
adding a reload amount to the card amount of the virtual debit card having the card number determined based on the unique transaction number in response to determining that the second request is for reloading the card amount, the reload amount being specified by the second request.

9. The method according to claim 6, wherein the receipt consists essentially of the unique transaction number, the card number, the card amount, a security code, and an expiration date of the virtual debit card.

10. The method according to claim 1, further comprising:
assigning personal identity information to the virtual debit card after receiving the request for the virtual debit card; and
transmitting the personal identity information of the virtual debit card to the terminal via the network,
wherein the personal identity information is configured to be included on the receipt provided by the terminal.

11. The method according to claim 1, wherein the request specifies whether the virtual debit card is to be one of single-use and multi-use.

12. The method according to claim 11, wherein funds required for the virtual debit card are variable depending at least on whether the request specifies that the virtual debit card is to be the one of the single-use and the multi-use.

13. The method according to claim 1, further comprising:
receiving funds from the terminal via the network with the request for the virtual debit card, the funds being at least equal to the card amount of the virtual debit card.

14. The method according to claim 1, further comprising:
forwarding the request for the virtual debit card to an issuing bank processor,
wherein the issuing bank processor determines the card number of the virtual debit card, and the card number of the virtual debit card is received from the issuing bank processor when determining the card number of the virtual debit card.

15. The method according to claim 14, further comprising:
receiving a first unique transaction number from the issuing bank processor in association with the card number of the virtual debit card;
assigning a second unique transaction number to the request for the virtual debit card in response to receiving the first unique transaction number from the issuing bank processor, the second unique transaction number being stored in the memory in association with the first unique transaction number;
transmitting the second unique transaction number to the terminal via the network,
wherein the second unique transaction number is configured to be included on the receipt provided by the terminal along with the card number of the virtual debit card and is useable by the user for being anonymously associated with the virtual debit card.

16. The method according to claim 14, further comprising:
receiving funds from the terminal via the network with the request for the virtual debit card, the funds being at least equal to the card amount of the virtual debit card; and
forwarding at least a portion of the funds to one of the issuing bank processor and an issuing bank when forwarding the request for the virtual debit card to the issuing bank processor.

17. The method according to claim 1, further comprising:
receiving a pre-request for the virtual debit card from the user;
transmitting a pre-request confirmation indicator to the user after receiving the pre-request for the virtual debit card,
wherein the terminal transmits the request for the virtual debit card when the pre-request confirmation indicator and funds at least equal to the card amount are received by the terminal.

18. The method according to claim 1, further comprising:
transmitting a promotional code to the terminal via the network with the card number of the virtual debit card,
wherein the promotional code is configured to be included on the receipt provided by the terminal.

19. The method according to claim 1, further comprising:
receiving a promotional code from the terminal via the network, the promotional code being input at the terminal by the user and providing a benefit to the user.

20. The method according to claim 1, wherein the request for the virtual debit card is received from the terminal with the terminal being one of a retail register, an automated teller machine, and a kiosk.

21. The method according to claim 1, wherein the card number of the virtual debit card is configured to be unusable until a predetermined activation event is executed.

22. A terminal for processing a request for a virtual debit card, comprising:
a input configured to receive the request for the virtual debit card from a user, the request specifying a card amount of the virtual debit card;
a payment acceptor configured to accept funds at least equal to the card amount from the user;
a transmitter configured to transmit the request for the virtual debit card to one of a merchant processor and an issuing bank processor in response to the payment acceptor receiving the funds, the request being anonymous with respect to the user;
a receiver configured to receive at least a card number of the virtual debit card from the one of the merchant processor and the issuing bank processor; and
a receipt provider configured to provide a receipt to the user in response to the card number being received by the receiver from the one of the merchant processor and the issuing bank processor, the receipt including at least the card number received by the receiver.

23. The terminal according to claim 22, wherein the input is configured to receive the request for the virtual debit card without receiving any personal identity information from the user.

24. The terminal according to claim 22, wherein the receiver is configured to receive the card number of the virtual debit card and the receipt provider is configured to provide the receipt to the user without associating the card number of the virtual debit card with the user.

25. The terminal according to claim 22, wherein the request for the virtual debit card that is transmitted by the transmitter to the one of the merchant processor and the issuing bank processor consists essentially of a terminal identifier for identifying the terminal and the card amount of the virtual debit card.

26. The terminal according to claim 22,
wherein the receiver is configured to receive a unique transaction number from the one of the merchant processor and the issuing bank processor when receiving the card number of the virtual debit card,
the input is configured to receive a second request from the user for reloading the card amount of the virtual, the second request including a reload amount and the unique transaction number,
the transmitter is configured to transmit the second request, without transmitting any personal identity information of the user, to the one of the merchant processor and the issuing bank processor in response to the input receiving the reload request, and
the reload amount is added to the card amount of the virtual debit card in response to the transmitter transmitting the second request to the one of the merchant processor and the issuing bank processor.

27. The terminal according to claim 22, wherein the input includes a scanner configured to read a pre-request confirmation indicator that indicates the request for the virtual debit card from the user.

28. The terminal according to claim 22, wherein the input includes a biometric input configured to receive biometric data that indicates the request for the virtual debit card.

29. A system for processing a request for a virtual debit card, comprising:
a terminal configured to receive the request for the virtual debit card from a user and to transmit the request to a request processor, the request specifying a card amount of the virtual debit card and being anonymous with respect to the user of the terminal; and
the request processor configured to:
receive the request for the virtual debit card from the terminal via a network;
determine at least a card number of the virtual debit card after receiving the request for the virtual debit card from the terminal, the card number of the virtual debit card being associated with the card amount of the virtual debit card; and
transmit at least the card number of the virtual debit card to the terminal via the network,
wherein the terminal is configured to receive the card number of the virtual debit card from the request processor and to provide a receipt to the user including the card number of the virtual debit card.

30. The system according to claim 29, wherein the terminal receives the request for the virtual debit card from the user without receiving any personal identity information from the user.

31. The system according to claim 29, wherein the terminal is configured to receive the card number of the virtual debit card from the request processor and to include the card number on the receipt without associating the card number with the user.

32. The system according to claim 29, wherein the request received by the request processor from the terminal consists essentially of a terminal identifier for identifying the terminal and the card amount of the virtual debit card.

33. The system according to claim 29, wherein the request processor is further configured to:
assign a unique transaction number to the request for the virtual debit card in response to receiving the request for the virtual debit card from the terminal;
store the unique transaction number in association with the card number of the virtual debit card; and
transmit the unique transaction number to the terminal via the network,
wherein the terminal is configured to include the unique transaction number on the receipt along with the card number of the virtual debit card.

34. The system according to claim 33, wherein the request processor is further configured to:
receive a second request from the user via the network, the second request including the unique transaction number and being non-identifying of the card number of the virtual debit card; and
determine the card number of the virtual debit card based on the unique transaction number included in the second request in response to receiving the second request.

35. The system according to claim 34, wherein the second request is anonymous with respect to the user.

36. The system according to claim 34, wherein the request processor is further configured to:
determine whether the second request is for reloading the card amount of the virtual debit card having the card number determined based on the unique transaction number; and
add a reload amount to the card amount of the virtual debit card having the card number determined based on the unique transaction number in response to determining that the second request is for reloading the card amount, the reload amount being specified by the second request.
